(19) United States
(12) Patent Application Publication
(10) Pub. No.: US 2006/0104302 A1
(43) Pub. Date: May 18, 2006

(54) Method of configuring system layers for synchronous Ethernet

(75) Inventors: Jae-Hun Cho, Seoul (KR); Sang-Ho Kim, Hwaseong-si (KR); Jun-Ho Koh, Suwon-si (KR); Jong-Kwon Kim, Gunpo-si (KR); Yun-Je Oh, Yongin-si (KR); Jong-Ho Yoon, Goyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/265,983

(22) Filed: Nov. 3, 2005

(30) Foreign Application Priority Data
Nov. 18, 2004 (KR) 2004-94801
Jan. 4, 2005 (KR) 2005-628

(51) Int. Cl. H04L 12/413

(52) U.S. Cl. 370/445

(57) ABSTRACT

A method of configuring system layers for a synchronous Ethernet is provided. In the method, a physical layer takes charge of input and output of an Ethernet frame in direct relation to hardware, an xMII (x Media Independent Interface) layer connects the physical layer to a data link layer. The data link layer has a sync frame processor for processing a synchronous frame and an async frame processor for processing an asynchronous frame. A parser and multiplexer (MUX), included in the x MII layer, construct a super frame with a synchronous frame and an asynchronous frame, transmit the super frame through the physical layer, parse a received super frame into a synchronous frame and an asynchronous frame, and transmit the synchronous and asynchronous frames to the data link layer.

### CLAIM OF PRIORITY

This application claims priority under 35 U.S.C. § 119 to an application entitled “Method of Configuring System Layers for Synchronous Ethernet,” filed in the Korean Intellectual Property Office on Nov. 18, 2004 and assigned Serial No. 2004-94801, and an application entitled “Method of Configuring System Layers for Synchronous Ethernet,” filed in the Korean Intellectual Property Office on Jan. 4, 2005 and assigned Serial No. 2005-628, the contents of both of which are incorporated herein by reference.

### BACKGROUND OF THE INVENTION

1. Field of the Invention

The present invention relates generally to a synchronous Ethernet, and in particular, to a method of configuring system layers for a synchronous Ethernet.

2. Description of the Related Art

Ethernet is the most widespread LAN (Local Access Network) technology in use. The interfaces and protocols of Ethernet have been standardized as IEEE (Institute of Electrical and Electronics Engineers) 802.3.

Ethernet devices access the network competitively using the CSMA/CD (Carrier Sense Multiple Access/Collision Detect) protocol conforming to IEEE 802.3. The Ethernet devices send upper-layer service frames as Ethernet frames with IFG (Inter frame Gap) inbetween. Notably, the upper service frames are delivered in the order of their generation irrespective of their types.

FIG. 1 illustrates a conventional Ethernet layer architecture based on the IEEE 802.3 standard.

A layering baseline is illustrated in FIG. 1. The layers are classified into a physical (PHY) layer 11, a data link layer including a MAC (Medium Access Control) layer 13 and a bridging layer 14, and an xMII (x Media Independent Interface) layer 12 between the PHY layer 11 and the data link layer. The PHY layer 11, which is the lowest layer in the OSI layer model, is used for reception and transmission of Ethernet frames in direct relation to hardware. The MAC layer 13 constructs an Ethernet frame with packets received from upper layers 15-1, 15-2 and 15-3 and delivers the Ethernet frame to the PHY layer 11. It also packetizes an Ethernet frame received from the PHY layer 11 and delivers the packets to the upper layers. The bridging layer 14 analyzes a received Ethernet frame and determines whether to bridge it according to information included in the Ethernet frame. When it determines to bridge the Ethernet frame, the bridging layer 14 bridges it forward to a destination. The xMII layer 12 is an 802.3 MAC-PLS (Physical Layer signaling) interface layer.

As the Ethernet is based on the CSMA/CD protocol which grants the same priority to all Ethernet frames and sends them competitively, the Ethernet is generally not suitable for carrying time delay-sensitive data such as moving pictures and voice. However, techniques for transmitting synchronous data like video and audio data in the conventional Ethernet are under development. This type of Ethernet is called a synchronous Ethernet.

In the synchronous Ethernet, a synchronous frame (sync frame) takes priority over an asynchronous frame (async frame) in transmission. Therefore, the existing Ethernet layer structure illustrated in FIG. 1 has limitations for the synchronous Ethernet. In this context, a need exists for configuring a novel layer structure suitable for the synchronous Ethernet.

IEEE 802.3p has been proposed for the conventional Ethernet in order to reduce delay by giving COS (Classification Of Service) to high-priority data such as multimedia data. While the IEEE 802.3p technology is effective to some extent due to transmission of multimedia data with priority, compared to the conventional IEEE 802.3 Ethernet technology, it requires a procedure for requesting a band for each data and allocating the band in order to be compete with the slot reservation of the synchronous Ethernet in which each slot is allocated for transmission. Nevertheless, such a band requesting and allocating procedure has not been developed. As a result, a bandwidth manager is needed to manage band allocation. The bandwidth management, however, increases the size of a jitter buffer.

Consequently, since the requirement for the existing IEEE 802.3p technology is different from the synchronous Ethernet, the layer structure of the former is not viable for the latter. Hence, a need exists for designing a novel layer structure for the synchronous Ethernet.

In addition, the novel layer structure needs to be designed to reflect the existing IEEE 802.3 layer structure as much as possible so that the synchronous Ethernet can be supported without a large-scale modification to existing devices.

### SUMMARY OF THE INVENTION

One aspect of the present invention relates to a method for configuring a synchronous Ethernet layer structure such that a synchronous Ethernet can be implemented still using existing PHY layer and MAC layer devices.

One embodiment of the present invention is directed to a structure in which a physical layer is provided for taking charge of input and output of an Ethernet frame in direct relation to hardware, an xMII (x Media Independent Interface) layer is provided for connecting the physical layer to a data link layer, and the data link layer is provided to have a sync frame processor for processing a synchronous frame and an async frame processor for processing an asynchronous frame. A parser and multiplexer (MUX) are included in the x MII layer, for constructing a super frame with a synchronous frame and an asynchronous frame, transmitting the super frame through the physical layer, parsing a received super frame into a synchronous frame and an asynchronous frame, and transmitting the synchronous and asynchronous frames to the data link layer.

According embodiment of the present invention is directed to a structure in which a physical layer is provided for taking charge of input and output of an Ethernet frame in direct relation to hardware. A MAC layer is provided for constructing an Ethernet frame with packets received from an upper layer, transmitting the Ethernet frame to the physical layer, converting an Ethernet frame received from the physical layer to packets, and transmitting the packets to the upper layer. A bridging layer is provided for analyzing a received Ethernet packet, deciding whether to bridge the Ethernet packet based on information included in the Ethernet packet, and transmitting the Ethernet packet to a destination when it is determined to bridge the Ethernet packet. A sync frame processor is provided for processing a synchronous packet among Ethernet packets. A parser and multiplexer (MUX) layer is included between the MAC layer and the bridging layer, for constructing a super packet with a synchronous packet and an asynchronous packet, transmitting the super packet through the MAC layer, parsing a super packet received from the MAC layer into a synchronous packet and an asynchronous packet, and transmitting the synchronous and asynchronous packets to the bridging layer.

### BRIEF DESCRIPTION OF THE DRAWINGS

The above and other aspects, features and embodiments of the present invention will become more apparent from the following detailed description when taken in conjunction with the accompanying drawings in which:

FIG. 1 illustrates a conventional Ethernet layer architecture based on the IEEE 802.3 standard;

FIG. 2 illustrates a transmission cycle for a synchronous Ethernet to which the present invention may be applied;

FIG. 3 illustrates a synchronous Ethernet layer structure according to one embodiment of the present invention;

FIG. 4 is a detailed block diagram of a sync frame processor as an entity for processing sync frames in a data link layer in the synchronous Ethernet layer structure according to one aspect of the present invention;

FIG. 5 illustrates the format of a sync sub-frame in the synchronous Ethernet to which the present invention may be applied; and

FIG. 6 illustrates a synchronous Ethernet layer structure according to another embodiment of the present invention.

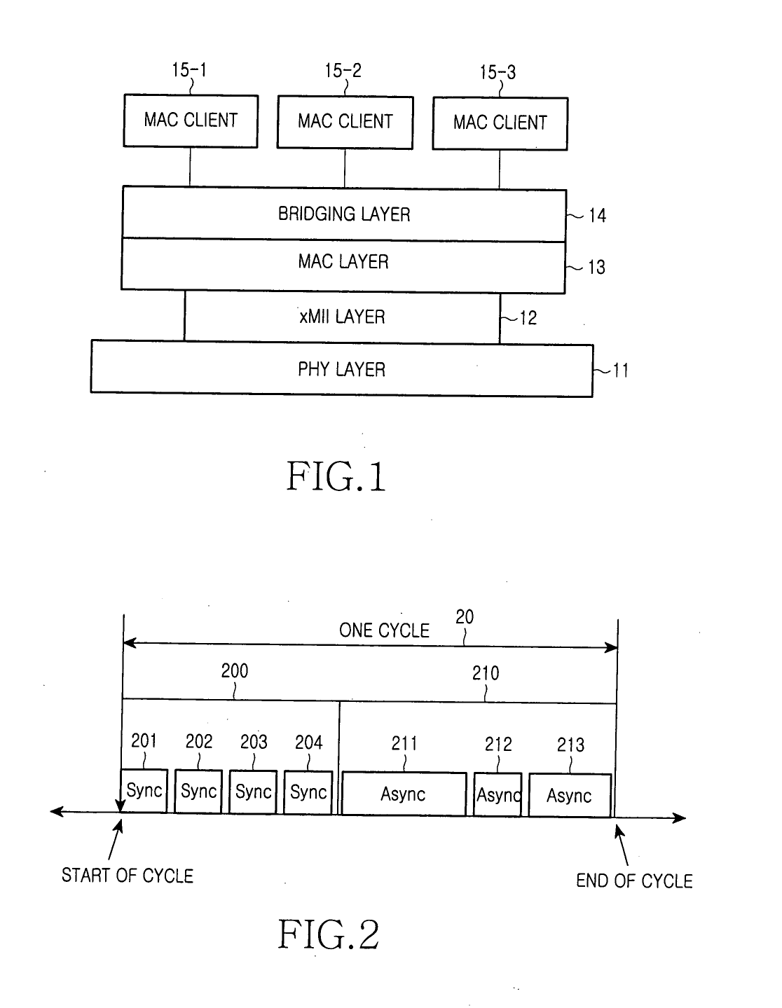

### DETAILED DESCRIPTION

Embodiments of the present invention will be described herein below with reference to the accompanying drawings. For the purposes of clarity and simplicity, well-known functions or constructions are not described in detail as they would obscure the invention in unnecessary detail.

Information communication technology has been developed toward integration of data, audio, and video. Thus, the boundaries among broadcasting, communications, and video industries fade and they will be merged. It will be appreciated by one skilled in the art that digital broadcasting will accelerate this phenomenon.

FIG. 2 illustrates the structure of a transmission cycle in a synchronous Ethernet to which the present invention may be applied.

Referring to FIG. 2, one cycle 20 for data transmission is 125 μs in the synchronous Ethernet. The cycle 20 is divided into a sync frame period 200 for transmission of synchronous data and an async frame period 210 for transmission of asynchronous data.

The sync frame period 200 takes priority over the async frame period 210 in the cycle 20. In one embodiment, the sync frame period 210 includes 738-byte synchronous sub-frames (sync sub-frames) 201 to 204.It should be understood, however, that the exact number of bytes could be changed.

The async frame period 210 includes asynchronous sub-frames (async sub-frames) 211, 212 and 213, each of a variable size.

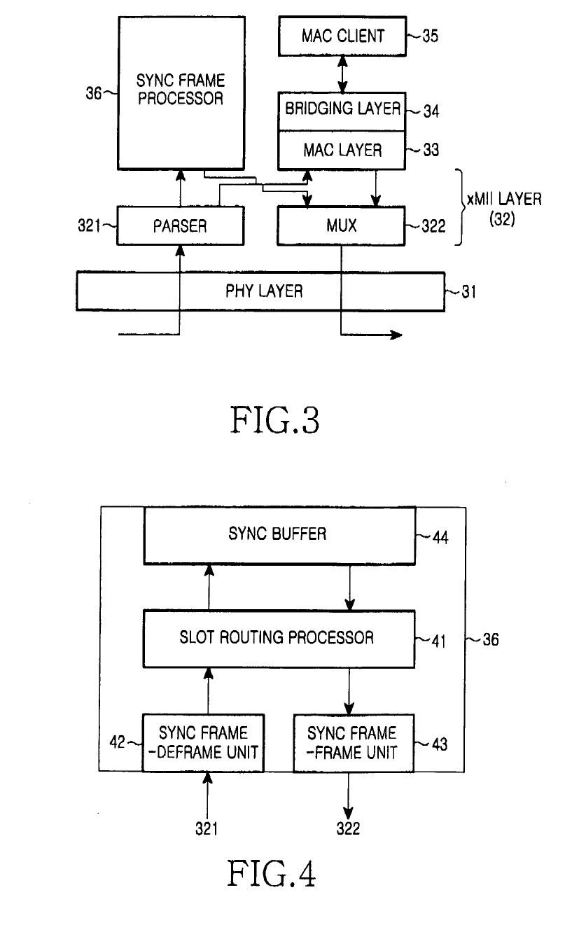

In accordance with one aspect of the present invention, a synchronous Ethernet layer structure is designed such that the super frame of the 125-μs transmission cycle is divided into the sync frame period and the async frame period, transmission data such as multimedia data is transmitted without time delay, while its QoS (Quality of Service) is guaranteed through slot reservation. The compatibility with the IEEE 802.3 is also maintained. This synchronous Ethernet layer structure is illustrated in FIGS. 3 and 6.

Referring to FIG. 3 illustrating an embodiment of the synchronous Ethernet layer structure, it is comprised of a PHY layer 31, which is the lowest layer of the OSI layer model. The PHY layer 31 is used for reception and transmission of Ethernet frames in direct relation to hardware. The Ethernet layer structure also includes an xMII layer 32 being a 802.3 MAC-PLS interface layer for interfacing between the PHY layer 31 and a data link layer, a sync frame processor 36 for processing a sync frame in and above a MAC layer 33, and an async frame processor for processing an async frame in and above the MAC layer 33. The async frame processor is implemented in both the MAC layer 33 and a bridging layer 34. The MAC layer 33 constructs an Ethernet frame with packets received from an upper layer 35 and delivers the Ethernet frame to the PHY layer 31. It also packetizes an Ethernet frame received from the PHY layer 31 and delivers the packets to the upper layer 35. The bridging layer 34 analyzes a received Ethernet frame and determines whether to bridge it according to information included in the Ethernet frame. When the bridging layer 34 determines to bridge the Ethernet frame, the bridging layer 14 bridges it forward to a destination.

The xMII layer 32 includes a parser 321 for parsing a synchronous Ethernet frame into sync sub-frames and async sub-frames and delivering them to the upper layers 33 and 35 according to their characteristics, and a multiplexer (MUX) 322 for multiplexing sync sub-frames received from the sync frame processor 36 and async sub-frames received from the async frame processor into one cycle.

The sync frame processor 36 is illustrated in detail in FIG. 4.

FIG. 4 is a block diagram of the sync frame processor as a data link layer entity for processing sync frames in the synchronous Ethernet layer structure of the present invention.

Referring to FIG. 4, the sync frame processor 36 is includes a sync buffer 44 connected to an upper layer that processes multimedia information. The sync buffer 44 buffers data to ensure continuity in data input and output. The sync frame processor 36 also a slot routing processor 41 connected to the sync buffer 44, for providing a path from/to the upper layer, a sync frame-frame unit 43 for generating a sync header for sync data received from the upper layer through the slot routing processor 41 and transmitting the sync data to a lower layer (e.g., the MUX 322), and a sync frame-deframe unit 42 for deleting a sync header from a sync sub-frame received from the lower layer (e.g. the parser 321) and providing the resulting sync sub-frame to the buffer 44 through the slot routing processor 41.

It is possible to configure the sync frame-frame unit 43, the sync frame-deframe unit 42, and the slot routing processor 44 in software.

Now a description will be made of the operation of the inventive synchronous Ethernet layer structure with reference to FIGS. 3 and 4.

Regarding a downlink signal (i.e. a signal from an upper layer to a lower layer) with reference to FIG. 3, upon receipt of multimedia data (i.e. sync packets) supporting an ASI interface such as broadcasting data through the corresponding interface, the received multimedia data is buffered in the sync buffer 44 of the sync frame processor 36. The slot routing processor 41 allocates a slot to the payload of the buffered data. The sync frame-frame unit 43 constructs a sync sub-frame by creating a sync header for the slot-allocated payload. The sync header includes information about a frame count indicating the count of a sync sub-frame and a cycle count indicating the count of a transmission cycle, and slot routing information associated with slot allocation and slot reservation information which are generated in the slot routing processor 41.

The sync sub-frame constructed in the sync frame processor 36 is multiplexed with an async sub-frame from the async frame processor in the MUX 322 of the xMII layer 32. This results in a synchronous Ethernet frame for one transmission cycle. The synchronous Ethernet frame is sent to other Ethernet devices through the PHY layer 31. The async frame processor including the bridging layer 34 and the MAC layer 33 operates as in the data link layer of the typical IEEE 802.3 Ethernet system.

Regarding an uplink signal, the parser 321 of the xMII layer 32 parses a synchronous Ethernet frame received through the PHY layer 31 into a sync frame and an async frame and provides the sync frame to the sync frame processor 36 and the async frame to the async frame processor. The async frame processor including the bridging layer 34 and the MAC layer 33 operates as in the data link layer of the typical IEEE 802.3 Ethernet system.

In the sync frame processor 36, the sync frame-deframe unit 42 extracts multimedia data from sync sub-frames in the sync frame. The slot routing processor 41 determines a routing path for the multimedia data based on information about the slot of the payload and provides the multimedia data to a corresponding upper layer through the sync buffer 44, guaranteeing QoS.

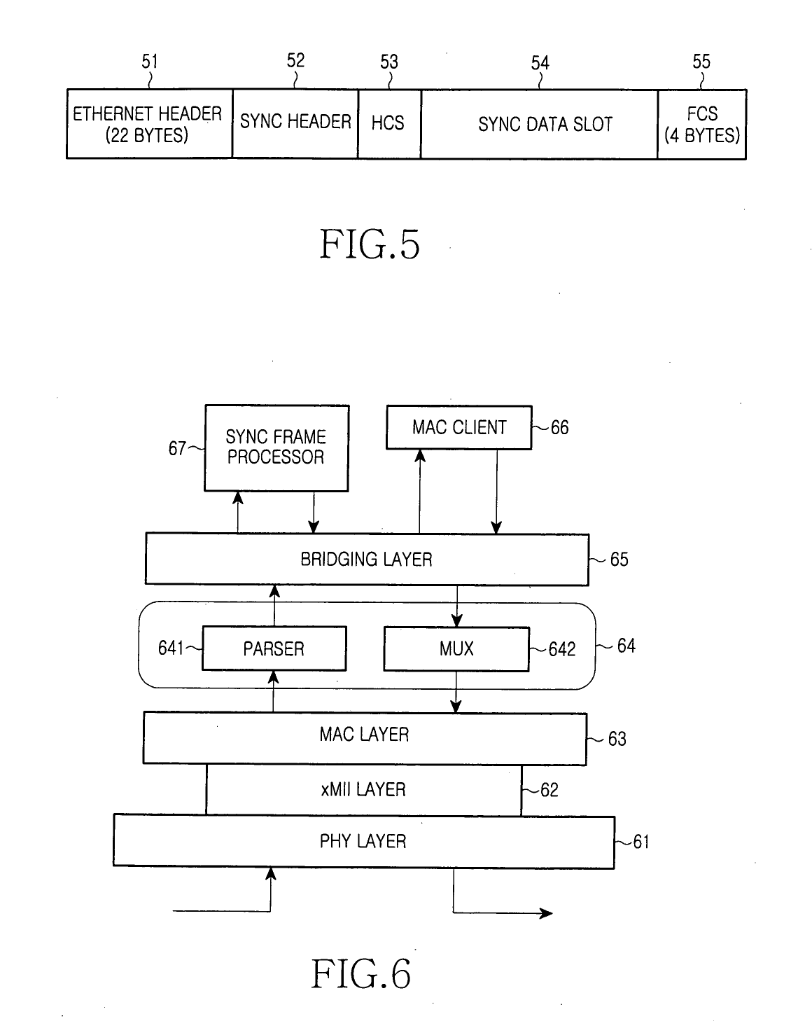

FIG. 5 illustrates the structure of a sync sub-frame in the synchronous Ethernet to which the present invention may be applied.

Referring to FIG. 5, in this embodiment, the sync sub-frame includes a 22-byte Ethernet Header 51 with typical Ethernet header information, and a 32-byte Sync Header 52 with frame count information indicating the count of the sync sub-frame, cycle count information indicating the count of a cycle for transmitting the sync sub-frame, and slot routing information and slot reservation information related to slot allocation. The sync sub-frame also includes a HCS (Header Check Sequence) 53, a Sync Data Slot 54 being the payload of multimedia data, and a 4-byte FCS (Frame Check Sequence) 55 for error detection in the sync sub-frame.

In accordance with the embodiment illustrated in FIGS. 3, 4 and 5, the MUX 322 multiplexes sync sub-frames and async sub-frames received from the upper layers 36 and 33 into a super frame being a synchronous Ethernet frame for one 125-μs cycle. To do so, a signal indicating the start of a super frame is inserted into the first sync sub-frame in the super frame every 125 μs.

To distinguish the sync sub-frames from the async sub-frames in the super frame, information indicating a sync sub-frame is included in each sync sub-frame. Alternatively, information discriminating the sync sub-frames from the async sub-frames is included in each of the sync sub-frames and the async sub-frames.

To efficiently process the async sub-frames in the super frame and accurately maintain the 125-μs transmission cycle against jitter in the 125-μs cycle, the async sub-frames are held or segmented. Accordingly, the length information of the async frame must be managed.

The parser 321 of the xMII layer 32 receives a super frame from the PHY layer 31 and synchronizes to the super frame by searching for a signal indicating the start of the super frame every 125 μs. It also parses the super frame into sync sub-frames and async sub-frames by searching for signals discriminating the sync sub-frames from async sub-frames.

The parsed async sub-frames are provided to the MAC layer 33. If the async sub-frames were held or segmented prior to transmission to prevent loss of synchronization due to jitter of a 125 μs-cycle in the transmitter, they are processed in the reverse order to this operation before transmission to the MAC layer 33.

FIG. 6 illustrates an alternative embodiment of the synchronous Ethernet layer structure.

Referring to FIG. 6, the synchronous Ethernet layer structure includes a PHY layer 61, which is the lowest layer in the OSI layer model. The PHY layer 61 is used for reception and transmission of Ethernet frames in direct relation to hardware. The synchronous Ethernet layer structure also includes an xMII layer 62 that is a 802.3 MAC-PLS interface layer for interfacing between the PHY layer 61 and a data link layer and a MAC layer 63 for constructing an Ethernet frame with packets received from upper layers 66 and 67 and delivering the Ethernet frame to the PHY layer 61, or packetizing an Ethernet frame received from the PHY layer 61 and providing the resulting packets to the upper layers 66 and 67. The synchronous Ethernet layer structure further includes a bridging layer 65 for analyzing a received Ethernet packet, determining whether to bridge it according to information included in the Ethernet packet, and if determining to bridge the Ethernet frame, bridging it forward to a destination, a sync frame processor 67 for processing sync packets above the MAC layer 63, and a parser/MUX layer 64 between the MAC layer 63 and the bridging layer 65, for constructing a super packet with a sync packet and an async packet and providing the super packet to the MAC layer 63, or parsing a super packet received from the MAC layer 63 into a sync packet and an async packet and providing the sync packet and the async packet to the bridging layer 65.

Compared to the first embodiment of the present invention, the parser 641 and the MUX 642 reside above the MAC layer 63, not in the xMII layer 62. In this case, information indicating the start of a super frame and information distinguishing sync sub-packets from async sub-packets are included in an Ethernet Header. Therefore, parsing can be performed based on information resulting from processing in the MAC layer 63. The information indicating the start of a super frame and information distinguishing sync sub-packets from async sub-packets are stored before generation of an Ethernet frame in the MAC layer 63. Information indicating the start of a super frame and information distinguishing sync sub-packets from async sub-packets are set in “TYPE” fields of sync sub-packets packet that form a sync sub-frame.

Regarding a downlink signal (i.e. a signal from an upper layer to a lower layer) with reference to FIG. 3, upon receipt of multimedia data (i.e. sync packets) supporting an ASI interface such as broadcasting data through the corresponding interface, the received multimedia data is buffered in the sync buffer 44 of the sync frame processor 67. The slot routing processor 41 allocates a slot to the payload of the buffered data. The sync frame-frame unit 43 constructs a sync sub-frame by creating a sync header for the slot-allocated payload. The sync header includes information about a frame count indicating the count of the sync sub-frame and a cycle count indicating the count of the transmission cycle, and slot routing information associated with slot allocation and slot reservation information which are generated in the slot routing processor 41.

The sync sub-frame constructed in the sync frame processor 67 and an async sub-frame from the MAC client 66 are provided to the parser/MUX layer 64 through the bridging layer 65 and multiplexed into a synchronous Ethernet packet for one transmission cycle in the MUX 642 of the parser/MUX layer 64. The synchronous Ethernet frame is sent to other Ethernet devices through the MAC layer 63.

Regarding an uplink signal, the MAC layer 63 extracts an Ethernet Header from a synchronous Ethernet frame received from the PHY layer 61, and the parser 641 of the parser/MUX layer 64 parser the synchronous Ethernet frame received from the MAC layer 63 and provides the parsed data to the sync frame processor 67 and the MAC client 66 through the bridging layer 65.

Now a third embodiment of the present invention will be described. As in the second embodiment, the synchronous Ethernet layer structure of the third embodiment includes the PHY layer 61, the xMII layer 62, the MAC layer 63, the bridging layer, the sync frame processor 67, and the parser/MUX layer 64.

However, in contrast to the second embodiment, information indicating the start of a 125-μs super frame and information distinguishing sync sub-packets from async sub-packets in the super frame are set in Sync Headers. This means that parsing is possible based on information obtained from processing in the MAC layer 63. The information indicating the start of a super frame and information distinguishing sync sub-packets from async sub-packets are stored before generation of an Ethernet frame in the MAC layer 63. This information is set in the Sync Header of a sync sub-frame.

As described above in the embodiment above, a synchronous Ethernet layer configuration method in which a synchronous Ethernet is implemented using existing PHY and MAC layer devices. This results in a synchronous Ethernet that can transmit multimedia data via existing Ethernet systems.

In addition, this structure provides compatibility with existing devices in protocol layers, thereby improving the competitive power of the synchronous Ethernet.

The above-described methods of the present invention can be programmed on a recording medium (e.g. CD ROM, RAM, floppy disk, hard disk, opto-magnetic disk, etc.) in the form readable by a computer.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method of configuring system layers for a synchronous Ethernet, comprising the steps of:
providing a physical layer for taking charge of input and output of an Ethernet frame in direct relation to hardware;
providing an xMII (x Media Independent Interface) layer for connecting the physical layer to a data link layer; and
providing the data link layer having a sync frame processor for processing a synchronous frame and an async frame processor for processing an asynchronous frame;
wherein a parser and a multiplexer (MUX) are included in the x MII layer, for constructing a super frame with a synchronous frame and an asynchronous frame, transmitting the super frame through the physical layer, parsing a received super frame into a synchronous frame and an asynchronous frame, and transmitting the synchronous and asynchronous frames to the data link layer.

2. The method of claim 1, wherein the MUX includes information discriminating synchronous sub-frames from asynchronous sub-frames in each of synchronous sub-frames and asynchronous sub-frames included in the super frame.

3. The method of claim 2, wherein the MUX includes information indicating the start of the super frame in the first synchronous sub-frame among the synchronous sub-frames in the super frame.

4. The method of claim 3, wherein the parser detects information indicating the start of the super frame and synchronizes to the super frame according to the detected information.

5. A method of configuring system layers for a synchronous Ethernet, comprising the steps of:
providing a physical layer for taking charge of input and output of an Ethernet frame in direct relation to hardware;
providing a MAC (Medium Access Control) layer for constructing an Ethernet frame with packets received from an upper layer, transmitting the Ethernet frame to the physical layer, converting an Ethernet frame received from the physical layer to packets, and transmitting the packets to the upper layer;
a bridging layer for analyzing a received Ethernet packet, deciding whether to bridge the Ethernet packet based on information included in the Ethernet packet, and transmitting the Ethernet packet to a destination when it is determined to bridge the Ethernet packet; and
providing a sync frame processor for processing a synchronous packet among Ethernet packets,
wherein a parser and multiplexer (MUX) layer is included between the MAC layer and the bridging layer, for constructing a super packet with a synchronous packet and an asynchronous packet, transmitting the super packet through the MAC layer, parsing a super packet received from the MAC layer into a synchronous packet and an asynchronous packet, and transmitting the synchronous and asynchronous packets to the bridging layer.

6. The method of claim 5, wherein the MUX includes information discriminating synchronous sub-packets from asynchronous sub-packets in each of synchronous sub-packets and asynchronous sub-packets included in the super packet.

7. The method of claim 5, wherein the MUX includes information indicating the start of the super packet in the first synchronous sub-packet among the synchronous sub-packets in the super packet.

8. The method of claim 6, wherein information discriminating synchronous sub-packets from asynchronous sub-packets and information indicating the start of a super packet are included in a TYPE field of each of the synchronous sub-packets and the asynchronous sub-packets.

9. The method of claim 7, wherein information discriminating synchronous sub-packets from asynchronous sub-packets and information indicating the start of a super packet are included in a TYPE field of each of the synchronous sub-packets and the asynchronous sub-packets.

10. The method of claim 6, wherein the information discriminating synchronous sub-packets from asynchronous sub-packets and the information indicating the start of a super packet are included in a synchronous header of a synchronous sub-frame.

11. The method of claim 7, wherein the information discriminating synchronous sub-packets from asynchronous sub-packets and the information indicating the start of a super packet are included in a synchronous header of a synchronous sub-frame.

12. The method of claim 10, wherein the synchronous header includes a frame count indicating the count of a synchronous sub-frame, a cycle count indicating the count of a transmission cycle for the synchronous sub-frame, slot routing information for slot allocation, and slot reservation information.

13. The method of claim 11, wherein the synchronous header includes a frame count indicating the count of a synchronous sub-frame, a cycle count indicating the count of a transmission cycle for the synchronous sub-frame, slot routing information for slot allocation, and slot reservation information.

14. A synchronous Ethernet layer structure comprising:
a physical layer for taking charge of input and output of an Ethernet frame in direct relation to hardware;
a data link layer having a sync frame processor for processing a synchronous frame and an async frame processor for processing an asynchronous frame; and
an xMII (x Media Independent Interface) layer for connecting the physical layer to a data link layer, a parser and a multiplexer (MUX) being included in the x MII layer, for constructing a super frame with a synchronous frame and an asynchronous frame, transmitting the super frame through the physical layer, parsing a received super frame into a synchronous frame and an asynchronous frame, and transmitting the synchronous and asynchronous frames to the data link layer.

15. The synchronous Ethernet layer structure of claim 14, wherein the MUX includes information discriminating synchronous sub-frames from asynchronous sub-frames in each of synchronous sub-frames and asynchronous sub-frames included in the super frame.

16. The synchronous Ethernet layer structure of claim 15, wherein the MUX includes information indicating the start of the super frame in the first synchronous sub-frame among the synchronous sub-frames in the super frame.

17. The synchronous Ethernet layer structure of claim 16, wherein the parser detects information indicating the start of the super frame and synchronizes to the super frame according to the detected information.

18. A synchronous Ethernet layer structure comprising:
a physical layer for taking charge of input and output of an Ethernet frame in direct relation to hardware;
a MAC (Medium Access Control) layer for constructing an Ethernet frame with packets received from an upper layer, transmitting the Ethernet frame to the physical layer, converting an Ethernet frame received from the physical layer to packets, and transmitting the packets to the upper layer;
a bridging layer for analyzing a received Ethernet packet, deciding whether to bridge the Ethernet packet based on information included in the Ethernet packet, and transmitting the Ethernet packet to a destination when it is determined to bridge the Ethernet packet; and
a sync frame processor for processing a synchronous packet among Ethernet packets,
wherein a parser and multiplexer (MUX) layer is included between the MAC layer and the bridging layer, for constructing a super packet with a synchronous packet and an asynchronous packet, transmitting the super packet through the MAC layer, parsing a super packet received from the MAC layer into a synchronous packet and an asynchronous packet, and transmitting the synchronous and asynchronous packets to the bridging layer.

19. The synchronous Ethernet layer structure of claim 18, wherein the MUX includes information discriminating synchronous sub-packets from asynchronous sub-packets in each of synchronous sub-packets and asynchronous sub-packets included in the super packet.

20. The synchronous Ethernet layer structure of claim 18, wherein the MUX includes information indicating the start of the super packet in the first synchronous sub-packet among the synchronous sub-packets in the super packet.
